(19) United States
(12) Patent Application Publication
(10) Pub. No.: US 2025/0206982 A1
(43) Pub. Date: Jun. 26, 2025

(54) LAMINATE

(71) Applicant: AGC Inc., Tokyo (JP)

(72) Inventors: Seiya URANO, Tokyo (JP); Shuhei OCHI, Tokyo (JP)

(73) Assignee: AGC Inc., Tokyo (JP)

(21) Appl. No.: 19/077,209

(22) Filed: Mar. 12, 2025

Related U.S. Application Data
(63) Continuation of application No. PCT/JP2023/035192, filed on Sep. 27, 2023.

(30) Foreign Application Priority Data
Oct. 6, 2022 (JP) 2022-161560

(51) Int. Cl. C09D 175/12; C04B 41/00; C04B 41/48; C04B 41/52; C04B 41/63; C04B 41/71; C09D 5/00; C09D 127/12; C09D 127/16; C09D 133/04; C09D 163/00

(52) U.S. Cl. CPC C09D 175/12; C04B 41/009; C04B 41/483; C04B 41/4842; C04B 41/4853; C04B 41/4884; C04B 41/52; C04B 41/63; C04B 41/71; C09D 5/002; C09D 127/12; C09D 127/16; C09D 133/04; C09D 163/00

(57) ABSTRACT

Provided is a laminate with good top layer adhesion and high water resistance. The laminate of the present invention includes a concrete substrate, a primer layer, a reinforcing layer and a fluorine-containing top layer in order of mention, wherein the primer layer contains a component selected from the group consisting of a cured epoxy resin product and a urethane resin, wherein the reinforcing layer contains a resin selected from the group consisting of a urea resin, a urethane resin and a urethane urea resin, and wherein the fluorine content in the top layer is more than 5 mass % and 55 mass % or less.

### TECHNICAL FIELD

The present invention relates to a laminate.

### BACKGROUND ART

It is a known technique to suppress flaking of concrete substrates by forming surface protection layers on the concrete substrates. Patent Document 1 discloses a laminate having, in the following order: a concrete substrate; a primer layer formed using an epoxy resin or the like; a reinforcing layer formed using an epoxy resin or the like; and a finishing layer formed using a fluorinated resin or the like.

### PRIOR ART DOCUMENTS

### Patent Documents

Patent Document 1: JP-A-2020-190109

### DISCLOSURE OF INVENTION

### Technical Problem

Recent years have seen a demand for concrete substrate-containing laminates with further improved performance, particularly high water resistance and good adhesion of the outermost layer (hereinafter also referred to as the top layer) among the layers disposed on the concrete substrate.

Here, when the adhesion of the top layer is not sufficient, the layer below the top layer is susceptible to damage, which can become a cause for flaking of the concrete substrate.

The present inventors have assessed the laminate disclosed in Patent Document 1 and found that, depending on the composition of the top layer, there is room for improvements in at least one of the water resistance of the laminate and the adhesion of the top layer.

The present invention has been made in view of the above-mentioned problems. It is an object of the present invention to provide a laminate with good top layer adhesion and high water resistance.

### Solution to Problem

As a result of intensive studies made to solve the above-mentioned problems, the present inventors have found that a laminate having, in the following order: a concrete substrate; a primer layer containing a specific resin; a reinforcing layer containing a specific resin; and a top layer containing fluorine achieves desired effects when the fluorine content in the top layer is in a specific range, and thus have accomplished the present invention.

Namely, the present inventors have found the following solutions to the above-mentioned problems.
[1] A laminate comprising a concrete substrate, a primer layer, a reinforcing layer and a fluorine-containing top layer in order of mention,
   wherein the primer layer comprises at least one selected from the group consisting of a cured epoxy resin product and a urethane resin,
   wherein the reinforcing layer comprises at least one selected from the group consisting of a urea resin, a urethane resin and a urethane urea resin, and
   wherein the fluorine content in the top layer is more than 5 mass % and 55 mass % or less.
[2] The laminate according to [1], wherein the fluorine content in the top layer is more than 5 mass % and 20 mass % or less.
[3] The laminate according to [1] or [2], wherein the top layer comprises a fluorinated polymer.
[4] The laminate according to [3], wherein the fluorinated polymer has units based on a fluoroolefin.
[5] The laminate according to [3] or [4],
   wherein the fluorinated polymer includes a fluorinated polymer F1 having units based on CF₂=CFCl, and
   wherein the content of the fluorinated polymer F1 is 50 mass % or more to the total mass of the fluorinated polymer.
[6] The laminate according to any one of [3] to [5], wherein the top layer further comprises a non-fluorinated polymer.
[7] The laminate according to [6], wherein the mass ratio of the content of the fluorinated polymer to the content of the non-fluorinated polymer in the top layer is 0.11 to 9.0.
[8] The laminate according to [6] or [7], wherein the non-fluorinated polymer is a (meth)acrylic resin.
[9] The laminate according to any one of [1] to [8], wherein the ratio of the thickness of the top layer to the thickness of the reinforcing layer is 0.002 to 0.200.
[10] The laminate according to any one of [1] to [9], wherein the top layer has a total transmittance of 30% or lower.

### Advantageous Effects of Invention

According to the present invention, it is possible to provide a laminate with good top layer adhesion and high water resistance.

### BRIEF DESCRIPTION OF DRAWINGS

FIG. 1 is a schematic side view illustrating an example of the laminate according to the present invention.

### DESCRIPTION OF EMBODIMENTS

The following terms used in the present invention have the following meanings.

A numerical range expressed using “to” means a range including numerical values described before and after “to” as the lower and upper limits.

A unit is a generic term for an atomic group derived from one molecule of monomer, which is directly formed by polymerization of the monomer, and an atomic group obtained by chemical conversion of a part of the aforementioned atomic group. The contents (mol %) of respective units to all the units in a polymer can be determined from the amounts of respective components used for production of the polymer.

“(Meth)acrylic” is a generic term for “acrylic” and “methacrylic”. An “(meth)acrylate” is a generic name for “acrylates” and “methacrylates”.

A hydrolyzable silyl group means a group that can be hydrolyzed to form a silanol group.

An acid value and a hydroxy value refer to values each measured according to the method defined in JIS K0070-3 (1992).

A glass transition temperature (Tg) means a midpoint glass transition temperature of a polymer as measured by a differential scanning calorimetry (DSC) method.

A number-average molecular weight (Mn) refers to a value measured by gel permeation chromatography using polystyrene as a standard.

A fluorine content (mass %) in a top layer means the amount of fluorine atoms in a material constituting the top layer, and can be determined based on the amounts of respective components used for formation of the top layer. This content value can alternatively be determined as a fluorine content (mass %) based on surface analysis of the top layer by X-ray fluorescence (XRF).

A thickness of a laminate refers to a value measured by an eddy-current coating thickness meter. As the eddy-current coating thickness meter, for example, a coating thickness meter EDY-5000 manufactured by SANKO ELECTRONIC LABORATORY CO., LTD. can be used. A thickness of each layer in the laminate can be determined from the thickness ratio of each layer, as obtained by cross-sectional observation of the laminate by a scanning electron microscope with an energy dispersive X-ray analyzer, and the thickness of the laminate.

A total transmittance refers to a value measured according to JIS K7361-1:1997 using a D light source.

A solid mass of a coating composition refers to, when the coating composition contains a solvent, a mass of a fraction obtained by removing the solvent from the coating composition. Any component of the coating composition other than the solvent is regarded as a solid even when it is in liquid form. Here, the solid mass of the coating composition is determined as the mass of a fraction remaining after heating 1 g of the coating composition at 130° C. for 20 minutes.

The laminate according to the present invention (hereinafter also referred to as the present laminate) has a concrete substrate, a primer layer, a reinforcing layer and a fluorine-containing top layer arranged in this order, wherein: the primer layer contains at least one selected from the group consisting of a cured epoxy resin product and a urethane resin; the reinforcing layer contains at least one selected from the group consisting of a urea resin, a urethane resin and a urethane urea resin; and the fluorine 10 content in the top layer is more than 5 mass % and 55 mass % or less.

The present laminate is excellent in adhesion of the top layer and is excellent in water resistance. The reason for these excellent properties is not yet clear but is estimated as follows. When the fluorine content in the top layer is more than 5 mass %, the water resistance of the laminate is improved by fully taking advantage of the water repellency of fluorine. When the fluorine content in the top layer is 55 mass % or less, the adhesion of the top layer to its adjacent reinforcing layer is improved due to the action of fluorine by increased compatibility between the top layer and reinforcing layer.

The configuration of the present laminate will be first described below with reference to the drawings.

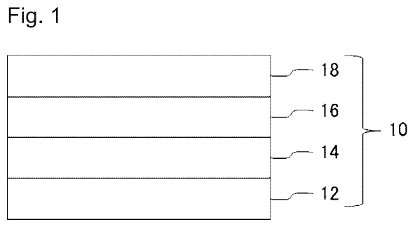

FIG. 1 is a schematic side view illustrating a layer structure of a laminate 10 according to an embodiment of the present invention. The laminate 10 has a concrete substrate 12, a primer layer 14, a reinforcing layer 16 and a top layer 18 arranged in this order.

In the laminate 10, an additional layer may be provided unless it is contrary to the spirit of the present invention.

Hereinafter, the respective constituent members of the present laminate will be described in detail below.

The present laminate has a concrete substrate. The concrete substrate refers to a substrate whose material contains concrete, and may contain a component other than the concrete (for example, a metal etc.)

The thickness of the concrete substrate is preferably 10 to 300 cm, more preferably 15 to 200 cm.

The present laminate has a primer layer. The primer layer serves to, for example, improve the applicability of a coating composition for formation of the adjacent layer and improve adhesion between the concrete substrate and the other layer.

The primer layer contains at least one component (hereinafter also referred to as a specific resin X) selected from the group consisting of a cured epoxy resin product and a urethane resin.

In the primer layer, one type of such a component may be used alone, or two or more types of such components may be used in combination.

The epoxy resin refers to a compound having two or more epoxy groups. The epoxy resin may additionally have reactive groups other than the epoxy groups.

Specific examples of the epoxy resin include bisphenol A epoxy resins, bisphenol F epoxy resins, phenol novolac epoxy resins, cresol novolac epoxy resins and aliphatic epoxy resins.

As the epoxy resin, also usable is an epoxy resin used for formation of a transparent primer layer as disclosed in JP-A-2020-190109.

The cured epoxy resin product refers to a cured product obtained by reaction of the epoxy resin with a curing agent (for example, an amine compound, an acid anhydride or a catalyst).

In the primer layer, two or more types of cured epoxy resin products may be used.

The urethane resin refers to a resin having urethane bonds, and can be obtained by reaction of e.g. a mixture containing a polyol (such as an acrylic polyol, a polyester polyol, a polyether polyol or propylene glycol) and at least one of an isocyanate compound and a urethane prepolymer.

As the urethane resin, also usable is a urethane resin used for formation of a transparent primer layer as disclosed in JP-A-2020-190109.

In the primer layer, two or more types of urethane resins may be used.

The content of the specific resin X to the total mass of the primer layer is preferably 10 to 100 mass %, more preferably 50 to 100 mass %.

The primer layer may contain a component other than the above-mentioned component. As such a component, an additive may be mentioned.

Specific examples of the additive usable in the primer layer include tetraethoxysilane.

In the case where the primer layer contains an additive, the content of the additive to the total mass of the primer layer is preferably 1 to 20 mass %, more preferably 5 to 10 mass %.

The thickness of the primer layer is preferably 5 to 100 μm, more preferably 10 to 80 μm.

The present laminate has a reinforcing layer. The reinforcing layer serves to, for example, suppress flaking of the concrete substrate.

The reinforcing layer contains at least one resin (hereinafter also referred to as a specific resin Y) selected from the group consisting of a urea resin, a urethane resin and a urethane urea resin. In the reinforcing layer, one type of such a component may be used alone, or two or more types of such components may be used in combination.

The urea resin refers to a resin having urea bonds, and can be obtained by reaction of e.g. a mixture containing an amine compound (such as a polyetheramine or an aromatic polyamine) and an isocyanate compound.

In the reinforcing layer, two or more types of urea resins may be used.

The details of the urethane resin are as described for the primer layer. In the reinforcing layer, two or more types of urethane resins may be used.

The urethane urea resin refers to a resin having urethane bonds and urea bonds, and can be obtained by reaction of e.g. a mixture containing a urethane resin having an isocyanate group at a terminal end thereof (urethane prepolymer) and an amine compound.

As the urethane urea resin, also usable is a resin produced from a coating material containing an isocyanurate compound, an isocyanate prepolymer and an alicyclic diamine compound as disclosed in JP-A-2020-190109.

In the reinforcing layer, two or more types of urethane urea resins may be used.

The content of the specific resin Y to the total mass of the reinforcing layer is preferably 10 to 100 mass %, more preferably 50 to 100 mass %.

The reinforcing layer may contain a component other than the above-mentioned component. As such a component, an additive may be mentioned.

Specific examples of the additive usable in the reinforcing layer include silica particles, an ultraviolet absorber and a light stabilizer.

In the case where the reinforcing layer contains an additive, the content of the additive to the total mass of the reinforcing layer is preferably 0.01 to 10 mass %, more preferably 0.1 to 8 mass %.

The thickness of the reinforcing layer is preferably 5 to 500 μm, more preferably 20 to 400 μm.

The present laminate has a fluorine-containing top layer. The top layer is arranged on the outermost side of the present laminate, and serves to protect the concrete substrate. The top layer of the present laminate also serves to improve the water resistance of the present laminate as mentioned above.

The fluorine content in the top layer is more than 5 mass % and 55 mass % or less, and is preferably more than 5 mass % and 20 mass % or less, more preferably 10 to 20 mass %.

When the fluorine content is more than 5 mass %, the present laminate achieves high water resistance. When the fluorine content is 55 mass % or less, the present laminate achieves good adhesion of the top layer.

With a view to achieving higher weather resistance of the present laminate, the top layer preferably includes a fluorinated polymer. In the top layer, two or more types of fluorinated polymers may be used in combination.

The fluorinated polymer may have or may not have a cross-linked structure.

The fluorinate polymer preferably contain units based on a fluoroolefin (hereinafter also referred to as units F-1) in terms of the water resistance and weather resistance of the present laminate.

The fluoroolefin refers to an olefin having one or more hydrogen atoms substituted by fluorine atoms. In the fluoroolefin, one or more of hydrogen atoms not substituted by fluorine atoms may be substituted by chlorine atoms. The number of carbon atoms in the fluoroolefin is preferably 2 to 8, particularly preferably 2 to 4.

Specific examples of the fluoroolefin include CF₂=CF₂, CF₂=CFCl, CF₂═CHF, CH₂=CF₂, CF₂═CFCF₃, CF₂═CHCF₃, CF₃CH═CHF, CF₃CF═CH₂ and monomers represented by CH₂═CX^{f1} (CF₂)ₙ₁ Y^{f1} (where X^{f1} and Y^{f1} are each independently a hydrogen atom or a fluorine atom; and n1 is an integer of 2 to 10). With a view to achieving high weather resistance of the present laminate, CF₂=CF₂, CH₂=CF₂, CF₂=CFCl, CF₃CH═CHF or CF₃CF═CH₂ is preferred; CF₂=CF₂ or CF₂═CFCl is more preferred; and CF₂=CFCl is further more preferred.

Two or more types of fluoroolefins may be used in combination.

In terms of the weather resistance of the present laminate, the content of the units F-1 to all the units in the fluorinated polymer is preferably 20 to 100 mol %, more preferably 30 to 70 mol %, still more preferably 40 to 60 mol %.

The fluorinated polymer may contain units (hereinafter also referred to as units F-2) having at least either aliphatic hydrocarbon rings or aromatic rings. The units F-2 are preferably units (hereinafter also referred to as units f2) based on a monomer having at least one of an aliphatic hydrocarbon ring and an aromatic ring.

Preferably, the unit F-2 contains no fluorine.

Specific examples of the aliphatic hydrocarbon ring include: monocyclic aliphatic hydrocarbons such as cyclobutane, cyclopentane, cyclohexane, cycloheptane and cyclooctane; polycyclic aliphatic hydrocarbons such 4-cyclohexylcyclohexane and decahydronaphthalene; norbornane and other aliphatic hydrocarbons having a bridged ring structure such as 1-adamantyl group; and aliphatic hydrocarbons having a spiro ring structure such as spiro[3.4] octyl group or the like.

Specific examples of the aromatic ring include: aromatic hydrocarbon rings such as benzene, toluene, xylene, naphthalene, phenol and benzoic acid; and aromatic heterocyclic rings such as furan, thiophene, pyrrole and pyridine.

The monomer f2 is preferably selected from a vinyl ether, a vinyl ester, an allyl ether, an allyl ester and a (meth)acrylic ester, each having at least one of an aliphatic hydrocarbon ring and an aromatic ring.

Specific examples of the monomer f2 include cyclohexyl (meth)acrylate, cyclohexyl vinyl ether, cyclohexanedimethanol monovinyl ether (CH₂=CHO—CH₂-cycloC₆H₁₀—CH₂OH), CH₂=CHCH₂O—CH₂-cycloC₆H₁₀—CH₂OH, CH₂=CHO—CH₂-cycloC₆H₁₀—CH₂—(OCH₂CH₂)₁₅OH, vinyl benzoate, vinyl tert-butylbenzoate and benzyl (meth)acrylate.

Here, “-cycloC₆H₁₀—” represents a cyclohexylene group, and the bonding sites of “-cycloC₆H₁₀—” are usually 1,4-positions.

The monomer f2 may be a combination of two or more types thereof.

In the case where the fluorinated polymer contains units F-2, the content of the units F-2 to all the units in the fluorinated polymer is preferably 20 to 50 mol %, more preferably 25 to 45 mol %, still more preferably 30 to 40 mol %.

The fluorinated polymer may contain units (hereinafter also referred to as units F-3) having neither aliphatic hydrocarbon rings nor aromatic rings and having at least either hydroxy groups or carboxy groups. Preferably, the unit F-3 contains no fluorine.

The units F-3 may be units based on a monomer (hereinafter also referred to as a monomer f3) having at least one of a hydroxy group and a carboxy group, or may be units obtained by modifying a fluorinated polymer containing units having groups convertible to hydroxy groups or carboxy groups to convert these convertible groups to at least either hydroxy groups or carboxy groups. Examples of such units include those obtained by reacting a fluorinated polymer containing hydroxy group-containing units with a polycarboxylic acid or an anhydride thereof etc. to convert all or part of the hydroxy groups to carboxy groups.

The hydroxy group or carboxy group of the monomer f3 may be at least partially cross-linked with a curing agent (for example, a compound having two or more isocyanate groups in the molecule, or a compound having two or more epoxy group in the molecule), or may remain without being cross-linked with a curing agent. When the hydroxy group or carboxy group of the monomer f3 is cross-linked with the curing agent, the present laminate achieves higher water resistance.

The monomer f3 having a hydroxy group may be a vinyl ether, a vinyl ester, an allyl ether, an allyl ester, a (meth)acrylic ester, each having a hydroxy group, an allyl alcohol, or the like. The monomer f3 having a hydroxy group is preferably a vinyl ether in terms of the weather resistance of the present laminate.

Specific examples of the monomer f3 having a hydroxy group include CH₂═CHOCH₂CH₂OH, CH₂=CHCH₂OCH₂CH₂OH, CH₂═CHOCH₂CH₂CH₂CH₂OH and CH₂=CHCH₂OCH₂CH₂CH₂CH₂OH. In terms of copolymerizability with the fluoroolefin CH₂=CHCH₂OCH₂CH₂OH or CH₂═CHOCH₂CH₂CH₂CH₂OH is preferred.

The monomer f3 having a carboxy group may be an unsaturated carboxylic acid, a (meth)acrylic acid, a monomer obtained by reaction of the above-mentioned hydroxy group-containing monomer with a carboxylic anhydride, or the like.

Specific examples of the monomer f3 having a carboxy group include CH₂═CHCOOH, CH(CH₃)═CHCOOH, CH₂═C(CH₃)COOH, HOOCCH═CHCOOH, CH₂═CH(CH₂)ₙ₁₁COOH (where n11 is an integer of 1 to 10) and CH₂═CHO(CH₂)ₙ₁₂OC(O)CH₂CH₂COOH (where n12 is an integer of 1 to 10). In terms of copolymerizability with the fluoroolefin, CH₂═CH(CH₂)n11COOH or CH₂═CHO(CH₂)ₙ₁₂OC(O)CH₂CH₂COOH is preferred.

The monomer f3 may be a combination of two or more types thereof.

In the case where the fluorinated polymer contains units F-3, the content of the units F-3 is preferably more than 0 mol % and 30 mol % or less, more preferably 1 to 15 mol %, still more preferably 1.5 to 5 mol %.

The fluorinated polymer may contain units (hereinafter also referred to as units F-4) based on a monomer (hereinafter also referred to as a monomer f4) having neither an aliphatic hydrocarbon ring nor an aromatic ring and having no hydroxy group and no carboxy group. Preferably, the unit F-4 contains no fluorine.

The unit F-4 may have a cross-linkable group other than a hydroxy group and a carboxy group. Specific examples of such a group include an amino group, an epoxy group, an oxetanyl group and a hydrolysable silyl group.

The monomer f4 may be at least one selected from the group consisting of an alkene, a vinyl ether, a vinyl ester, an allyl ether, an allyl ester and a (meth)acrylic ester. In terms of the copolymerizability with the fluoroolefin and the weather resistance of the obtainable fluorinated polymer, the monomer f4 is preferably at least one of a vinyl ether and a vinyl ester, particularly preferably a vinyl ether.

Specific examples of the monomer f4 include ethylene, propylene, 1-butene, ethyl vinyl ether, tert-butyl vinyl ether, 2-ethylhexyl vinyl ether, vinyl acetate, vinyl pivalate, vinyl neononanoate (product name “VeoVa 9”, manufactured by HEXION INC.), vinyl neodecanoate (product name “VeoVa 10”, manufactured by HEXION INC.) and tert-butyl (meth)acrylate.

The monomer f4 may be a combination of two or more types thereof.

In the case where the fluorinated polymer contains units F-4, the content of the units F-4 to all the units in the fluorinated polymer is preferably 10 to 40 mol %, more preferably 20 to 30 mol %.

The Tg of the fluorinated polymer is preferably 30 to 60° C., more preferably 45 to 50° C.

The Mn of the fluorinated polymer is preferably 1000 to 1000000.

In the case where the fluorinated polymer has a hydroxy value, the hydroxy value of the fluorinated polymer is preferably 10 to 100 mgKOH/g, more preferably 40 to 60 mgKOH/g.

The fluorinated polymer may be a combination of two or more types thereof.

In the case where the top layer includes a fluorinated polymer, the content of the fluorinated polymer to the total mass of the top layer is preferably 50 to 90 mass %, more preferably 60 to 80 mass %. When the content of the fluorinated polymer is 50 mass % or more, the present laminate achieves higher water resistance. When the content of the fluorinated polymer is 90 mass % or less, the present laminate achieves better adhesion of the top layer.

The fluorinated polymer is produced by a known method. For example, the fluorinated polymer can be produced by copolymerization of respective monomers in the presence of a solvent and a radical polymerization initiator. As examples of the method for producing the fluorinated polymer, solution polymerization and emulsion polymerization may be mentioned. During or after the production of the fluorinated polymer, a polymerization stabilizer, a polymerization inhibitor, a surfactant and the like may be used as needed.

The fluorinated polymer may be a commercially available product. Specific examples of the commercially available fluorinated polymer include “LUMIFLON” series (manufactured by AGC INC.), “Fluon” series (manufactured by AGC INC.), “Kynar” series (manufactured by Arkema Inc.), “ZEFFLE” series (manufactured by DAIKIN INDUSTRIES, LTD.), “Eterflon” series (manufactured by Eternal Materials Co., Ltd.) and “Zendura” series (manufactured by Honeywell Inc.).

A preferred embodiment of the top layer is that the top layer includes a fluorinated polymer F1 containing units based on CF₂═CFCl. The fluorinated polymer F1 is an embodiment of the above-mentioned fluorinated polymer.

In the case where the top layer includes a fluorinated polymer F1, the top layer may contain or may not includes a fluorinated polymer other than the fluorinated polymer F1 (that is, a fluorinated polymer having no units based on CF₂═CFCl).

In the case where the top layer includes a fluorinated polymer F1, the content of the fluorinated polymer F1 to the total mass of the fluorinated polymers in the top layer is preferably 50 mass % or more, more preferably 70 mass % or more, still more preferably 90 mass % or more. When the content of the fluorinated polymer F1 is 50 mass % or more, the present laminate achieves higher water resistance and better adhesion of the top layer.

In the case where the top layer includes a fluorinated polymer F1, the content of the fluorinated polymer F1 is preferably 100 mass % or less to the total mass of the fluorinated polymers in the top layer.

With a view to achieving better adhesion of the top layer, it is preferred that the top layer further includes a non-fluorinated polymer.

Specific examples of the non-fluorinated polymer include a (meth)acrylic resin, an alkyd resin, a polyester resin, an epoxy resin, a vinyl acetate resin, a vinyl chloride resin, a phenolic resin, a modified polyester resin, an acrylic silicone resin and a silicone resin. Among others, a (meth)acrylic resin is preferred to achieve better adhesion of the top layer.

The (meth)acrylic resin refers to a polymer containing units based on a (meth)acrylic ester or a cross-linked product thereof.

The (meth)acrylic ester may be, for example, an alkyl (meth)acrylate, an aryl (meth)acrylate or the like. Specific examples of the (meth)acrylic ester include methyl (meth)acrylate, ethyl (meth)acrylate, propyl (meth)acrylate, n-butyl (meth)acrylate, isobutyl (meth)acrylate, t-butyl (meth)acrylate, n-hexyl (meth)acrylate, cyclohexyl (meth)acrylate, lauryl (meth)acrylate, 2-ethylhexyl (meth)acrylate, benzyl (meth)acrylate and phenyl (meth)acrylate.

The (meth)acrylic ester may have a cross-linkable group such as a hydroxy group, a carboxy group, an amino group, an epoxy group, an oxetanyl group or a hydrolysable silyl group. The cross-linkable group may remain without reaction, or may be cross-linked to form an intramolecular cross linkage or cross-liked by a curing agent having a group reactable with the cross-linkable group.

The (meth)acrylic resin may be a combination of two or more types thereof.

The Tg of the non-fluorinated polymer is preferably −20 to 40° C., more preferably −15 to 30° C. When the Tg of the non-fluorinated polymer is in the above-mentioned range, good film forming properties are obtained.

In the case where the top layer includes a non-fluorinated polymer, the content of the non-fluorinated polymer to the total mass of the top layer is preferably 5 to 40 mass %, more preferably 10 to 30 mass %.

In the case where the top layer includes a fluorinated polymer and a non-fluorinated polymer, the mass ratio of the content of the fluorinated polymer to the content of the non-fluorinated polymer (content of fluorinated polymer/content of non-fluorinated polymer) is preferably 0.11 to 9.0, more preferably 1 to 7, still more preferably 2 to 5. When the mass ratio is 0.11 or higher, the present laminate achieves higher water resistance. When the mass ratio is 9.0 or lower, the present laminate achieves better adhesion of the top layer.

The top layer may contain a component other than the above-mentioned components. As such a component, an additive may be mentioned.

Examples of the additive include a curing agent, a curing catalyst, an ultraviolet absorber, a light stabilizer, a matting agent, a leveling agent, a surface conditioner, a degassing agent, a heat stabilizer, a thickener, a dispersant, a surfactant, an antistatic agent, a corrosion inhibitor, an antifouling agent, a stain reducing agent, a plasticizer and an adhesive.

In the case where the top layer contains an additive, the content of the additive to the total mass of the top layer is preferably more than 0 mass % and 10 mass % or less.

The thickness of the top layer is preferably 10 to 80 μm, more preferably 40 to 60 μm.

The ratio of the thickness of the top layer to the thickness of the reinforcing layer (thickness of top layer/thickness of reinforcing layer) is preferably from 0.002 to 0.200, more preferably from 0.01 to 0.190, still more preferably from 0.02 to 0.180. When this thickness ratio is 0.002 or higher, the present laminate achieves higher weather resistance and water resistance. When this thickness ratio is 0.200 or lower, the present laminate achieves better adhesion of the top layer.

The total transmittance of the top layer is preferably 30% or lower.

The top layer is preferably formed from a coating composition containing a fluorinated polymer (hereinafter also referred to as a present coating material). The fluorinated polymer in the present coating material is as described above.

The content of the fluorinated polymer to the solid mass of the present coating material is preferably 50 to 80 mass %, more preferably 60 to 70 mass %.

In the present coating material, the above-mentioned non-fluorinated polymer and additive etc. may be contained.

In the case where the non-fluorinated polymer is contained in the present coating material, the content of the non-fluorinated polymer to the solid mass of the present coating material is preferably 10 to 30 mass %, more preferably 15 to 25 mass %.

In the case where the additive is contained in the present coating material, the content of the additive to the solid mass of the present coating material is preferably more than 0 mass % and 30 mass % or less.

The present coating material may be in the form of a paint having the fluorinated polymer dissolved or dispersed in a liquid medium, or may be in the form of a paint (powder paint etc.) containing substantially no liquid medium.

The liquid medium can be an organic solvent or water. The paint in which the fluorinated polymer is dissolved or dispersed in the liquid medium can be a paint using an organic solvent as a dissolving medium (a solvent-based paint) or a paint using water as a dispersion medium (a water-based paint). The present coating material is preferably a water-based paint from the viewpoint of reduction of environmental impact.

When the present coating material contains substantially no liquid medium, it means that the content of the liquid medium to the total mass of the present coating material is 0.1 mass % or less.

The organic solvent can be a ketone solvent, an ester solvent, a hydrocarbon solvent, an alcohol solvent, a glycol ether solvent or a glycol ester solvent.

Specific examples of the ketone solvent include acetone, methyl ethyl ketone, methyl isobutyl ketone, diisobutyl ketone and diacetone alcohol.

Specific examples of the ester solvent include ethyl acetate and butyl acetate.

Specific examples of the hydrocarbon solvent include hexane, heptane, cyclohexane, xylene, toluene, Solvesso 100 manufactured by Exxon Mobil Corporation, Solvesso 150 manufactured by Exxon Mobil Corporation, and aromatic hydrocarbon solvents (such as Mineral spirit etc.).

Specific examples of the alcohol solvent include butyl alcohol.

Specific examples of the glycol ether solvent include ethylene glycol monoethyl ether, ethylene glycol monobutyl ether and propylene glycol monopropyl ether.

Specific examples of the glycol ester solvent include 1-methoxypropyl-2-acetate.

In the case where the present coating material contains a liquid medium, the content of the liquid medium to the total mass of the present coating material is preferably 10 to 95 mass %, more preferably 20 to 90 mass %.

For example, the present coating material can be produced by mixing the fluorinated polymer and optional components. The liquid medium may be a polymerization solvent used in production of the fluorinated polymer.

The present laminate may be produced by, for example, forming the primer layer on the substrate, forming the reinforcing layer on the primer layer and then forming the top layer on the reinforcing layer.

More specifically, each layer can be formed by applying a coating composition for formation of each layer with the use of a sprayer, an applicator, a die coater, a bar coater, a roll coater, a comma coater, a brush roller, a brush or a spatula.

In the case where the coating composition for formation of each layer contains a liquid medium, air drying or heat drying may be performed to remove the solvent in the coating composition after the application of the coating composition.

### EXAMPLES

Now, the present invention will be described in further detail with reference to Examples. Ex. 1 and Ex. 2 correspond to Examples of the present invention; and Ex. 3 and Ex. 4 correspond to Comparative Examples. It should however be understood that the present invention is by no means restricted to these Examples. In the table below, the amount of each component used is expressed on a mass basis.

### Abbreviations and Details of Components Used

### [Monomers]

CTFE: Chlorotrifluoroethylene
CHVE: Cyclohexyl vinyl ether
EVE: Ethyl vinyl ether
CHMVE: Cyclohexane dimethanol monovinyl ether
CM-EOVE: CH₂═CHOCH₂-cycloC₆H₁₀—CH₂O(CH₂CH₂O)ₙH (n=15)

### [Dispersions]

Dispersion D_{F10036}: Aqueous dispersion with particles of a fluorinated polymer F1 (hydroxy value: 49 mgKOH/g, fluorine content: 23 mass %, SP value: 17.8 (J/cm³)^{1/2}, average particle size: 150 nm, Tg: 45° C.) dispersed at a concentration of 50 mass % in water, wherein the fluorinated polymer F1 had 50 mol % units based on CTFE, 15 mol % units based on CHVE, 25 mol % units based on EVE, 9 mol % units based on CHMVE and 1 mol % units based on CM-EOVE to all the units in the fluorinated polymer.
Dispersion D_{F2}: Aqueous dispersion with particles of polyvinylidene fluoride as a fluorinated polymer F2 dispersed at a concentration of 50 mass % in water.
Dispersion D_{A1}: Aqueous dispersion YODOSOL AD-179 (manufactured by Henkel Ltd.) with particles of a (meth)acrylic resin A1 (Tg:−10° C.) dispersed at a concentration of 44 mass % in water.

### Ex. 1

### [Preparation of Reinforcing Layer-Forming Coating Composition]

A reinforcing layer-forming coating composition was prepared by uniformly mixing 49 parts by mass of an isocyanurate compound (Desmodur Z4470 BA (manufactured by Sumika Covestro Urethane Company, Ltd.), a trimer of isophorone diisocyanate), 100 parts by mass of the following isocyanate prepolymer P1, 53 parts by mass of an alicyclic diamine compound (Desmophen NH1420, manufactured by Sumika Covestro Urethane Company, Ltd.), 16 parts by mass of Mineral spirit, 13 parts by mass of hydrophobic silica, 1.7 parts by mass of a ultraviolet absorber and 1.7 parts by mass of a light stabilizer.

Isocyanate prepolymer P1: Prepolymer obtained by mixing 100 parts by mass of PTG L2000 (manufactured by Hodogaya Chemical Co., Ltd., a modified polytetramethylene glycol having a molecular weight of 2000) and 21 parts by mass of isophorone diisocyanate and reacting the resulting mixture at 80° C. for 2 hours in the presence of 0.003 parts by mass of NEOSTANN U-830 (manufactured by NITTO KASEI CO., LTD., dioctyltin, a catalyst).

### [Preparation of Top Layer-Forming Coating Composition]

A coating composition 1 was prepared as a water-based paint by mixing the dispersion D_{F1} (70 parts by mass), the dispersion D_{A1} (20 parts by mass) and a film forming aid (ethylene glycol mono-2-ethylhexyl ether (EHG), boiling point: 229° C.) (10 parts by mass).

### [Production of Laminate]

An epoxy resin (Bond VM Primer (manufactured by Konishi Co., Ltd., single-component epoxy resin) was applied in an amount of 0.12 kg/m² to a surface of a concrete substrate and left at room temperature (23° C.) for 12 hours, to form a primer layer containing a cured epoxy resin product.

The reinforcing layer-forming composition was applied in an amount of 1.0 kg/m² to a surface of the primer layer and left at room temperature (23° C.) for 12 hours, to form a reinforcing layer (thickness: 300 μm).

The coating composition 1 was then applied to a surface of the reinforcing layer and left at room temperature (23° C.) for 14 hours, to form a top layer. There was thus obtained a laminate of Ex. 1.

### Ex. 2 to Ex. 4

Top layer-forming coating compositions 2 to 4 were prepared in the same manner as in Ex. 1, except that the respective compositions of the top layer-forming coating compositions were varied as shown in Table 1. Laminates of Ex. 2 to Ex. 4 were obtained in the same manner as in Ex. 1, except that the prepared coating compositions were respectively used.

### [Fluorine Content in Top Layer]

The fluorine content in the top layer was determined from the amounts of the respective components charged and used for formation of the top layer.

### [Adhesion]

The adhesion of the top layer was evaluated by a cross-cut test (JIS K5600-5-6).

More specifically, cuts were free formed at spacings of 1 mm to define a lattice pattern of 100 squares in a top layer-side surface of each laminate. An adhesive tape was adhered to the top layer-side surface and then peeled off from the top layer-side surface. Among 100 squares, the number of squares (squares/100 squares) in which separation of the top layer did not occur due to peeling of the adhesive tape was counted. Based on the counted number of squares, the adhesion of the top layer was rated according to the following criteria. The results are shown in Table 1. It can be said that the adhesion of the top layer was good when rated as B or higher.
A: The counted number of squares was more than 95.
B: The counted number of squares was from 70 to 95.
C: The counted number of squares was less than 70.

### [Water Resistance]

Each laminate was immersed in hot water of 60° C. for 18 hours, immersed in cold water of 5° C. for 15 hours, and then, dried at 5° C. According to the following criteria, the water resistance of the laminate was rated based on the appearance of the laminate after the drying. The results are shown in Table 1. It can be said that the laminate was high in water resistance when rated as B or higher.
A: The occurrence of whitening or swelling was not seen at 80% or more of the surface area of the top layer.
B: The occurrence of whitening or swelling was not seen at 50 to 80% of the surface area of the top surface.
C: The occurrence of whitening or swelling was seen at more than 50% of the surface area of the top layer.

TABLE 1

| | | Ex. 1 | Ex. 2 | Ex. 3 | Ex. 4 |
|---|---|---|---|---|---|
| Fluorinated | F1 (Parts by mass) | 35 | 5 | 10 | — |
| polymer | F2 (Parts by mass) | — | 30 | — | 45 |
| (Meth)acrylic resin | A1 (Parts by mass) | 8.8 | 8.8 | 30.8 | — |
| Film forming aid (Parts by mass) | | 10 | 10 | 10 | 10 |
| Fluorine content (mass %) in top layer | | 16 | 36 | 5 | 59 |
| Ratings | Adhesion | A | B | — | C |
| | Water resistance | A | B | C | — |

As shown in Table 1, it has been demonstrated that the laminate of the present invention achieves good adhesion of the top layer and high water resistance (Ex. 1 and Ex. 2).

This application is a continuation of PCT Application No. PCT/JP2023/035192, filed on Sep. 27, 2023, which is based upon and claims the benefit of priority from Japanese Patent Application No. 2022-161560 filed on Oct. 6, 2022. The contents of those applications are incorporated herein by reference in their entireties.

### REFERENCE SYMBOLS

10: Laminate
12: Concrete substrate
14: Primer layer
16: Reinforcing layer
18: Top layer

What is claimed is:

1. A laminate comprising, in the following order, a concrete substrate, a primer layer, a reinforcing layer and a top layer containing fluorine,
wherein the primer layer comprises at least one selected from the group consisting of a cured epoxy resin product and a urethane resin,
wherein the reinforcing layer comprises at least one selected from the group consisting of a urea resin, a urethane resin and a urethane urea resin, and
wherein the fluorine content in the top layer is more than 5 mass % and 55 mass % or less.

2. The laminate according to claim 1, wherein the fluorine content in the top layer is more than 5 mass % and 20 mass % or less.

3. The laminate according to claim 1, wherein the top layer comprises a fluorinated polymer.

4. The laminate according to claim 3, wherein the fluorinated polymer has units based on a fluoroolefin.

5. The laminate according to claim 3,
wherein the fluorinated polymer includes a fluorinated polymer F1 having units based on CF₂=CFCl, and
wherein the content of the fluorinated polymer F1 is 50 mass % or more to the total mass of the fluorinated polymer

6. The laminate according to claim 3, wherein the top layer further comprises a non-fluorinated polymer.

7. The laminate according to claim 6, wherein the mass ratio of the content of the fluorinated polymer to the content of the non-fluorinated polymer is 0.11 to 9.0.

8. The laminate according to claim 6, wherein the non-fluorinated polymer is a (meth)acrylic resin.

9. The laminate according to claim 1, wherein the ratio of the thickness of the top layer to the thickness of the reinforcing layer is 0.002 to 0.200.

10. The laminate according to claim 1, wherein the top layer has a total transmittance of 30% or lower.
